(19) United States
(12) Patent Application Publication
(10) Pub. No.: US 2015/0268706 A1
(43) Pub. Date: Sep. 24, 2015

(54) SYSTEM AND METHOD FOR MEMORY POWER MANAGEMENT IN A SYSTEM ON A CHIP WITH MULTIPLE EXECUTION ENVIRONMENTS

(71) Applicant: QUALCOMM INCORPORATED, SAN DIEGO, CA (US)

(72) Inventors: TERO KUKOLA, SAN DIEGO, CA (US); CARL VICTOR STREETER, ERIE, CO (US); THOMAS ZENG, SAN DIEGO, CA (US); AJAYKUMAR SHANKARGOUDA PATIL, BANGALORE (IN); CHRISTOPHER ALAN PAGNOTTA, SAN MARCOS, CA (US); VINAY JAIN, BANGALORE (IN); SATYAKI MUKHERJEE, SAN DIEGO, CA (US); AZZEDINE TOUZNI, SAN DIEGO, CA (US)

(21) Appl. No.: 14/304,894

(22) Filed: Jun. 14, 2014

Related U.S. Application Data
(60) Provisional application No. 61/969,722, filed on Mar. 24, 2014.

(51) Int. Cl. G06F 1/26; G06F 21/64

(52) U.S. Cl. CPC G06F 1/26; G06F 21/64

(57) ABSTRACT

Various embodiments of methods and systems for hardware-based memory power management (“HMPM”) in a portable computing device (“PCD”) running secure and non-secure execution environments are disclosed. Hardware-based state machines are uniquely associated with, and under the control of, the non-secure execution environment, the secure execution environment and a virtual manager, respectively. The states of the state machines constitute votes by each of the execution environments and the virtual manager to control the power supply state to the memory component, such as a cache memory. The votes are monitored by a digital circuit that, based on a combination logic of the votes, generates an output signal to trigger a power management component to maintain, supply or remove power on a rail associated with the memory component. In this way, the power supply state to the memory component cannot be unilaterally changed by an application running in the non-secure execution environment.

### STATEMENT REGARDING RELATED APPLICATIONS

This application claims priority under 35 U.S.C.§119 as a non-provisional application of the U.S. Provisional Patent Application 61/969,722 filed on Mar. 24, 2014 and entitled SYSTEM AND METHOD FOR MEMORY POWER MANAGEMENT IN A SYSTEM ON A CHIP WITH MULTIPLE EXECUTION ENVIRONMENTS, the entire contents of which is hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

Because users often rely on their PCDs to process, store and manage sensitive data, some PCDs leverage multiple execution environments to control access to the sensitive data. For example, a processor within a PCD may toggle between processing application workloads within a non-secure execution environment and processing application workloads within a secure execution environment. As a result, the processor may use a common cache memory component to manage both non-secure and secure data.

To maintain the integrity of the secure data, applications running in a non-secure execution environment may not be allowed to control power states of a cache component without being authorized to do so by the secure execution environment. If an application running in the non-secure environment were allowed to power collapse the cache before the secure execution environment completes a flush of its secure data from the cache to a main memory component, such as a double data rate (“DDR”) memory component, updated states of the secure data in the cache may be lost. Additionally, the integrity of the secure data stored in the main memory component may be compromised as the application in the non-secure execution environment takes control of the cache upon reboot.

Accordingly, there is a need in the art to provide solutions that may effectively close the security loophole described above. Handshakes between software applications running in different execution environments, or polling of the execution environments via software, before a cache component is power collapsed may introduce latency issues to a PCD. Moreover, software-based solutions to close the security loophole may be easily corrupted or compromised. As such, there is a need in the art for a hardware-based system and method that manages power supply to a power consuming component, such as a cache memory component, of a system on a chip (“SoC”) having multiple execution environments.

### SUMMARY OF THE DISCLOSURE

Various embodiments of methods and systems for hardware-based memory power management (“HMPM”) in a portable computing device (“PCD”) running multiple execution environments are disclosed. One exemplary method includes instantiating a virtual manager, a non-secure execution environment and a secure execution environment in the PCD. Under the direction of the virtual manager, both the non-secure execution environment and the secure execution environment utilize a same processor and a same memory component that reside on a system on a chip (“SoC”) in the PCD. A first hardware-based state machine is uniquely associated with, and under the control of, the non-secure execution environment. A second hardware-based state machine is uniquely associated with, and under the control of, the secure execution environment. And, a third hardware-based state machine is uniquely associated with, and under the control of, the virtual manager.

The states of the state machines constitute votes by each of the execution environments and the virtual manager to control the power supply state to the memory component, such as a cache memory. The votes are monitored by a digital circuit that, based on a combination logic of the votes, generates an output signal to trigger a power management component, such as a power management integrated circuit (“PMIC”), to maintain, supply or remove power on a rail associated with the memory component. In this way, the power supply state to the memory component cannot be unilaterally changed by an application running in the non-secure execution environment.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an embodiment of an on-chip system for hardware-based memory power management (“HMPM”) in a portable computing device (“PCD”) running multiple execution environments;

FIG. 2 is a functional block diagram of an exemplary, non-limiting aspect of a PCD in the form of a wireless telephone for implementing methods and systems for hardware-based memory power management across multiple execution environments;

FIG. 3 is a circuit diagram of an exemplary HMPM embodiment for managing power states of a cache component in a system on a chip (“SoC”) running multiple execution environments; and

FIG. 4 is a logical flowchart illustrating an embodiment of a method for hardware-based memory power management in the PCD of FIG. 2.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference is made to “execution environments” including “non-secure execution environment” and “secure execution environment.” As one of ordinary skill in the art would recognize, an execution environment, whether non-secure or secure, may be viewed as a virtual machine. In this way, multiple execution environments may share hardware resources such as, but not limited to, processors and memory components. Secure environments, within the context of this document, are meant to refer to those execution environments that run applications authorized to access, manage and update sensitive data stored with a PCD. Conversely, non-secure environments, within the context of this document, are meant to refer to those execution environments that run applications not authorized to directly access, manage or update sensitive data otherwise controlled by a secure execution environment.

A non-secure execution environment, for example, may be used to execute code associated with a high level operating system (“HLOS”) and, as such, reference to an “HLOS” environment in this description may be interpreted as a reference to a non-secure execution environment. Conversely, a secure execution environment, for example, may be used to execute code associated with a TrustZone application and, as such, reference to a “TZ” environment in this description may be interpreted as a reference to a secure execution environment.

Further, in this description, the term “hypervisor” is meant to refer to a virtual machine manager in the form of a software program that marshals the access of multiple execution environments to one or more hardware components within a PCD. In this way, a hypervisor may be viewed as an execution environment for other execution environments. For example, when multiple execution environments are simultaneously instantiated in a PCD, a hypervisor may provide for each execution environment, whether secure or non-secure, to appear as if it has dedicated access to a set of hardware components even though each execution environment is actually sharing the hardware. As such, actual control of a set of hardware components resides within a hypervisor and not any particular execution environment.

In this description, general reference to the term “memory,” “memory component,” “memory device,” “computer-readable medium” or the like will be understood to envision both “volatile” and “non-volatile” types of memory components whether located “on-chip,” “off-chip,” “internal,” “external” or otherwise relative to a PCD. Further, although generally depicted in this description as a single component, any of the various memory components may be a distributed memory device with separate data stores coupled to a digital signal processor (or additional processor cores).

Reference to a cache memory, unless specifically stated otherwise, is meant to refer to the broader class of random access memory (“RAM”) that a processing component may initially access when seeking certain data. As one of ordinary skill in the art would understand, when a processor processes data, it may look first in the cache memory and, if it finds the data there, it may forego the more time-consuming task of seeking the data from a larger memory component. Cache memory may be referred to in levels of closeness and accessibility a processing component, as one of ordinary skill in the art would recognize. An “L1” cache, for example, may be located on the processor itself. An “L2” cache may be co-located with a processor but be a separate static RAM (“SRAM”) chip. An “L3” cache may function as a main RAM that is a dynamic RAM (“DRAM”) chip. It is envisioned that embodiments of HMPM solutions seek primarily to manage power states of one or more L2 or L3 cache components.

Although it is envisioned that certain aspects of certain HMPM embodiments may be associated with cache memory components, as mentioned above, the scope of this description will not be limited to such an extent that particular aspects of embodiments are uniquely associated with cache memory. As such, a memory component in this description may be, but is not limited to being, a flash memory type such as a MultiMediaCard (“MMC” or “eMMC”) or Secure Digital (“SD”) card, a semiconductor type such as a static random-access memory (“SRAM”) that must be constantly powered or a dynamic random access memory (“DRAM”) that must be periodically refreshed, a solid-state memory, an electrical connection having one or more wires, a portable computer diskette (magnetic), an electronic read-only memory (“ROM”), an erasable programmable read-only memory (“EPROM” or “EEPROM”), an optical fiber, a portable compact disc read-only memory (“CDROM”), etc. Moreover, depending on the particular embodiment, an HMPM embodiment may manage power states of any power consuming component that exists on a SoC within a PCD and is used by a plurality of execution environments.

In this description, one or more of the aspects of an HMPM solution are implemented in hardware. Notably, it is envisioned that the various logic of those aspects may be implemented with any or a combination of the following technologies, which are each well known in the art: a discrete logic circuit(s) having logic gates for implementing logic functions upon data signals, an application specific integrated circuit (“ASIC”) having appropriate combinational logic gates, a programmable gate array(s) (“PGA”), a field programmable gate array (“FPGA”), etc.

As used in this description, the terms “component,” “database,” “module,” “system” and the like are intended to refer to a computer-related entity, either hardware, firmware, a combination of hardware and software, software, or software in execution and represent exemplary means for providing the functionality and performing the certain steps in the processes or process flows described in this specification. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “modem CPU,” “digital signal processor (“DSP”),” “chip” and “chipset” are non-limiting examples of processing components that may reside in a PCD and are used interchangeably except when otherwise indicated. Moreover, as distinguished in this description, a CPU, DSP, or a chip or chipset may be comprised of one or more distinct processing components generally referred to herein as “core(s)” and “sub-core(s).” Further to that which is defined above, a “processing component” may be, but is not limited to, a central processing unit, a graphical processing unit, a core, a main core, a sub-core, a processing area, a hardware engine, etc. or any component that resides within, or external to, an integrated circuit within a portable computing device and may be used to instruct a memory component or other hardware component, including itself, to enter a sleep, idle or standby state.

In this description, the term “state machine” refers to a mathematical model of computation used to dictate an input to a logical circuit for controlling power supply to a power consuming component (e.g., cache memory) associated with multiple execution environments. A state machine may be viewed as existing in one of a finite number of states represented in binary by either a “1” or a “0.” As such, a state machine is in only one state at a time—a current state. Notably, a state machine may transition from one state to another when initiated by a triggering event or condition, such as an application in a given execution environment executing an instruction for triggering the transition.

Because PCD users often rely on their PCDs to process, store and manage sensitive data, some PCDs leverage multiple execution environments to control access to the sensitive data (e.g., encryption keys for premium content, passwords, HLOS image, secure image for banking transactions, etc.). For example, a processor within a PCD may toggle between processing application workloads within a non-secure execution environment and processing application workloads within a secure execution environment. As a result, the processor may use a common cache memory component, such as an L2 cache or L3 cache, to manage both non-secure and secure data.

As one of ordinary skill in the art would understand, the data in the cache may be the most “up to date” as the processor may have “read” or “written” to it numerous times since initially querying the data from a larger memory component. Consequently, power collapsing the cache (i.e., transitioning the cache to a power saving mode) before the data stored therein is flushed to a larger memory store (such as a DDR or external flash memory) may be detrimental to the function of the PCD. Further, because in a PCD running secure and non-secure execution environments the data stored in the cache by secure applications must be safeguarded from potentially compromised code running in the non-secure environment, it is desirable to prevent non-secure applications from taking unauthorized control of the cache. If an application running in the non-secure environment were allowed to power collapse the cache, the integrity of the secure data stored in the cache may be compromised as the application in the non-secure execution environment takes control of the cache upon reboot. The end result may be corruption of the secure execution environment and/or control of the secure execution environment by a non-secure application.

Accordingly, embodiments of HMPM systems and methods leverage a hardware block in control of the cache power supply to seek input from all relevant execution environments before power collapsing a cache. In this way, HMPM embodiments may preclude non-secure software from being able to unilaterally power the cache down. For example, in a SoC that has instantiated a non-secure execution environment and a secure execution environment, both environments may have to produce a key before a certain cache memory is power collapsed or awakened.

It is envisioned that exemplary HMPM embodiments may be implemented in a SoC running a high level operating system (“HLOS”) in a non-secure execution environment, a secure application in a TrustZone (“TZ”) execution environment and a Hypervisor for marshaling access to various hardware components residing on the SoC. Each entity (HLOS, TZ and Hypervisor) may control a state machine represented by a set of hardware registers. Advantageously, the state machines are uniquely associated with each entity and, as such, the HLOS cannot transition the current state of a state machine associated with the TZ or Hypervisor. Using a power collapse (“PC”) module to read the current states of the various state machines, the power supplied to a cache component, for example, may be gated by the combination of the various state machines. In this way, embodiments of HMPM systems and methods may prevent a non-secure software application, such as an HLOS, from unilaterally power collapsing a cache component or some other security-critical component residing on the SoC and accessibly by multiple execution environments.

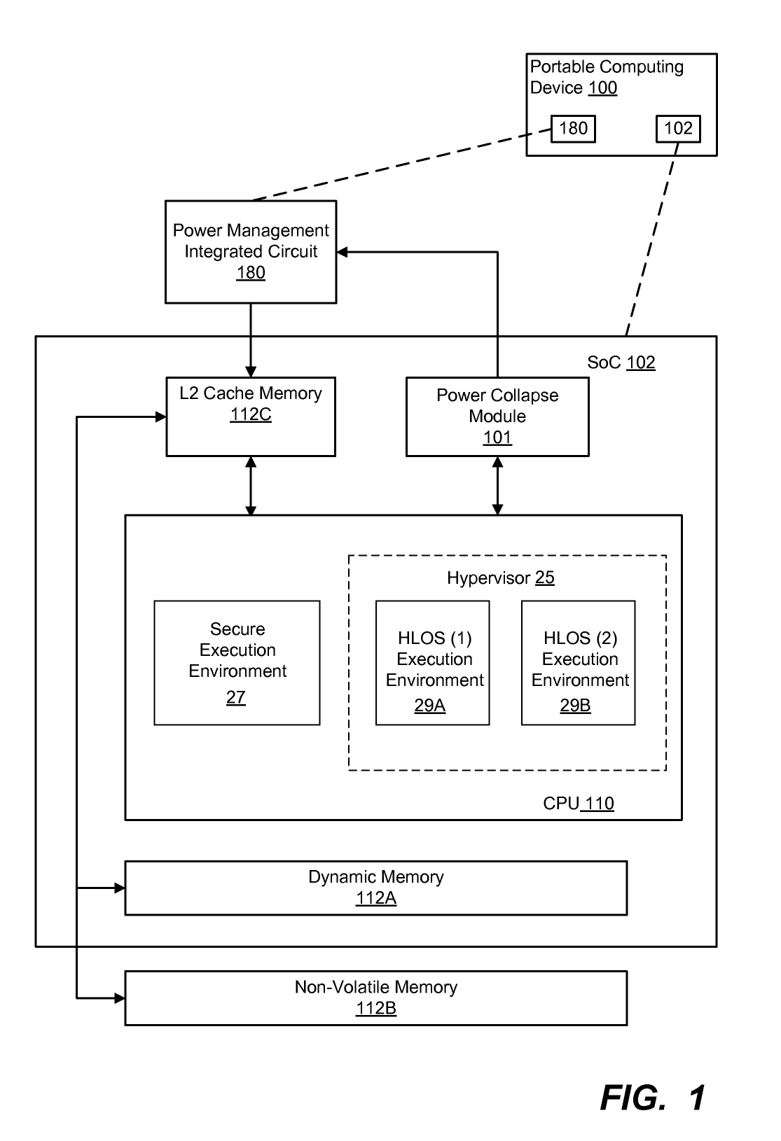

FIG. 1 is a functional block diagram illustrating an embodiment of an on-chip system 102 for hardware-based memory power management (“HMPM”) in a portable computing device (“PCD”) 100 running multiple execution environments 27, 29. In the FIG. 1 illustration, a system on a chip (“SoC”) 102 is depicted to include a CPU 110 running one or more applications associated with a secure execution environment 27, such as a TrustZone (“TZ”) environment, and a non-secure execution environment 29, such as a HLOS environment. As would be understood by one of ordinary skill in the art, the CPU 110 is a hardware resource that may be used by either or both of the execution environments 27, 29 to process workload threads. The Hypervisor 25 controls access to the CPU 110 by the execution environments 27, 29. Notably, although in the FIG. 1 illustration the Hypervisor 25, TZ environment 27 and HLOS environment 29 are depicted within the CPU 110, one of ordinary skill in the art will recognize that all or part of the code and data associated with each may actually reside in a memory component 112 not physically a part of the CPU 110. That is, the Hypervisor 25, TZ environment 27 and HLOS environment 29 are depicted within the CPU 110 for illustrative purposes.

A power management integrated circuit (“PMIC”) 180 supplies power to the various hardware component residing on the SoC 102 including the CPU 110, an L2 cache memory 112C and a dynamic memory 112A (such as a DDR memory, for example). In operation, the PMIC 180 toggles power supply to the cache 112C based on a state generated by the power collapse (“PC”) module 101.

As an example, the cache 112C may be powered such that the CPU 110 may read or write data to the cache 112C according to workloads processed on behalf of the TZ environment 27 and the HLOS environment 29. Upon completion of a workload, the HLOS environment 29 may vote that the cache 112C be power collapsed in order to conserve power, mitigate thermal energy generation, etc. Consequently, the current state of a state machine (state machines not explicitly represented in the FIG. 1 illustration) uniquely associated with the HLOS environment 29 may be transitioned to a “vote” that the cache 112C be power collapsed. The Hypervisor 25, recognizing that the HLOS environment 29 has voted to power collapsed the cache 112C may elect to also transition the state of its state machine to vote for a cache power collapse and inform the TZ environment 27 of the present votes. Subsequently, the TZ environment 27 may complete any workload processing that requires updating of secure data in the cache 112C and then instruct the cache 112C to be flushed to the dynamic memory 112A and/or an external memory 112B (such as a non-volatile flash memory, for example) and cleaned. Once the TZ environment 27 has completed its tasks, it may elect to transition the state of its associated state machine to indicate a vote for power collapse of the cache 112C. The TZ environment 27 may also issue a wait for interrupt (“WFI”) instruction in anticipation of the power collapse.

All the votes from the state machines are received by the PC module 101 and, in combination, dictate an output state from the PC module 101 which either instructs the PMIC 180 to continue powering the cache 112C or power collapse the cache 112C. Notably, although the exemplary HMPM embodiments are described herein relative to two states—a “power on” state and a “power collapse” state—it is envisioned that certain HMPM embodiments may leverage state machines associated with multiple execution environments to dictate more than two power states to a cache memory or other power consuming components shared by execution states. For example, it is envisioned that some HMPM embodiments may work to recognize state machine vote combinations that dictate reduced power levels to a power consuming component in lieu of, or in addition to, full power on and power collapse levels. Regardless, it is an advantage of HMPM solutions that power supply to a power consuming component, such as a cache 112C, may not be hijacked or controlled by one executing environment to the detriment of another.

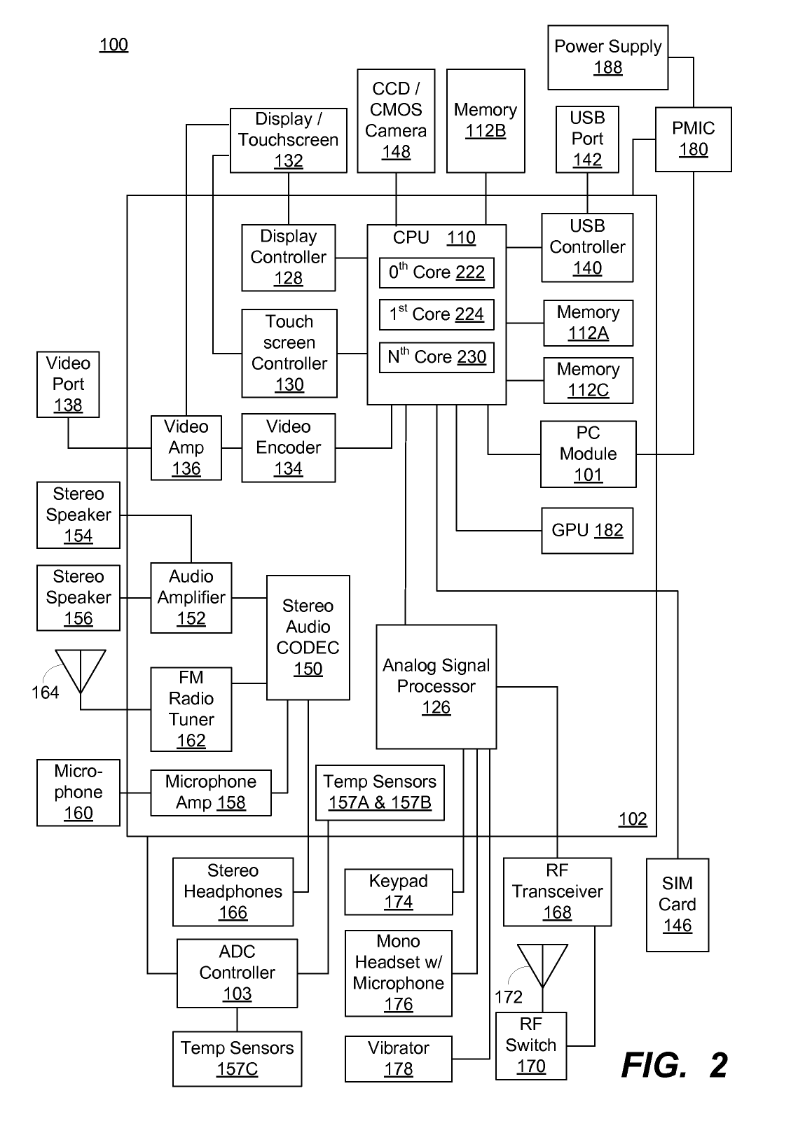

FIG. 2 is a functional block diagram of an exemplary, non-limiting aspect of a PCD 100 in the form of a wireless telephone for implementing methods and systems for hardware-based memory power management (“HMPM”) across multiple execution environments. As shown, the PCD 100 includes an on-chip system 102 that includes a central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art. Moreover, as is understood in the art of heterogeneous multi-core processors, each of the cores 222, 224, 230 may process different workloads associated with differing applications or functionality of the PCD 100 running in various execution environments.

In general, the PC module(s) 101 may be responsible for recognizing current states and state transitions of multiple state machines associated with secure and non-secure execution environments. Based on the state combinations, the PC module(s) 101 may trigger a PMIC 180 to supply or remove power to a power rail associated with a power consuming component on the chip 102, such as a memory component 112. Application of the HMPM solutions may prevent an unauthorized takeover, hacking, or unauthorized access to secure data by an application running in a non-secure execution environment. In this way, the PC module(s) 101 may optimize QoS provided to the user by ensuring that authorized control of power collapse and/or reboot of a power-consuming component shared across multiple execution environments, such as a cache 112C, is not compromised.

In HMPM systems and methods, the PC module(s) 101 may be formed from hardware to generate triggers based on recognized states from finite state machines associated with various execution environments and other stakeholders in the PCD 100. That is, the PC module(s) 101 may take the form of a digital circuit comprised of logic gates for implementing a Boolean function to generate logical outputs from one or more logical inputs. Certain PC module(s) 101 may be configured to and operational to dictate the power states of any of memory components 112. For instance, in certain embodiments, a PC module 101 forming all or part of an HMPM solution may dictate the power supply state to a cache 112C that is shared across multiple execution environments via its association with CPU 110. Similarly, and briefly referring back to the FIG. 1 illustration, a PC module 101 forming all or part of an HMPM solution may dictate the power state of a non-volatile memory 112B that is located off-chip and/or an on-chip DRAM memory, such as volatile memory 112A. In still other embodiments, it is envisioned that a PC module 101 forming all or part of an HMPM solution may simply control the “online” or “offline” status of a given component associated with PCD 100.

As illustrated in FIG. 2, a display controller 128 and a touch screen controller 130 are coupled to the CPU 110. A touch screen display 132 external to the on-chip system 102 is coupled to the display controller 128 and the touch screen controller 130.

PCD 100 may further include a video decoder 134, e.g., a phase-alternating line (“PAL”) decoder, a sequential couleur avec memoire (“SECAM”) decoder, a national television system(s) committee (“NTSC”) decoder or any other type of video decoder 134. The video decoder 134 is coupled to the central processing unit (“CPU”) 110. A video amplifier 136 is coupled to the video decoder 134 and the touch screen display 132. A video port 138 is coupled to the video amplifier 136. As depicted in FIG. 2, a universal serial bus (“USB”) controller 140 is coupled to the CPU 110. Also, a USB port 142 is coupled to the USB controller 140. On-chip memory components 112A, 112C may also be coupled to the CPU 110. All or part of memory component 112C may actually reside within CPU 110 in the form of an L1 cache. Notably, memory component 112C may also include L2 and L3 cache, as is understood in the art. An off-chip memory component 112B, such as but not limited to a flash memory, and a subscriber identity module (SIM) card 146 may be external to chip 102 and coupled to CPU 110. Further, as shown in FIG. 2, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 188, for example a battery, is coupled to the on-chip system 102 via a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A and 157B as well as one or more external, off-chip thermal sensors 157C. The on-chip thermal sensors 157A, 157B may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors. The thermal sensors 157 may produce a voltage drop that is converted to digital signals with an analog-to-digital converter (“ADC”) controller 103 (See FIG. 5A). However, other types of thermal sensors 157 may be employed without departing from the scope of the invention.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157C, memory 112B, PMIC 180 and the power supply 188 are external to the on-chip system 102.

In a particular aspect, one or more of the method steps described herein to trigger state transitions in state machines associated with various execution environments may be implemented by executable instructions and parameters stored in the memory 112 and executed by the CPU 110, the analog signal processor 126, the GPU 182, or another processor, in addition to the ADC controller 103. Further, the processors 110, 126, the memory 112, the instructions stored therein, or a combination thereof may serve as a means for performing one or more of the method steps described herein.

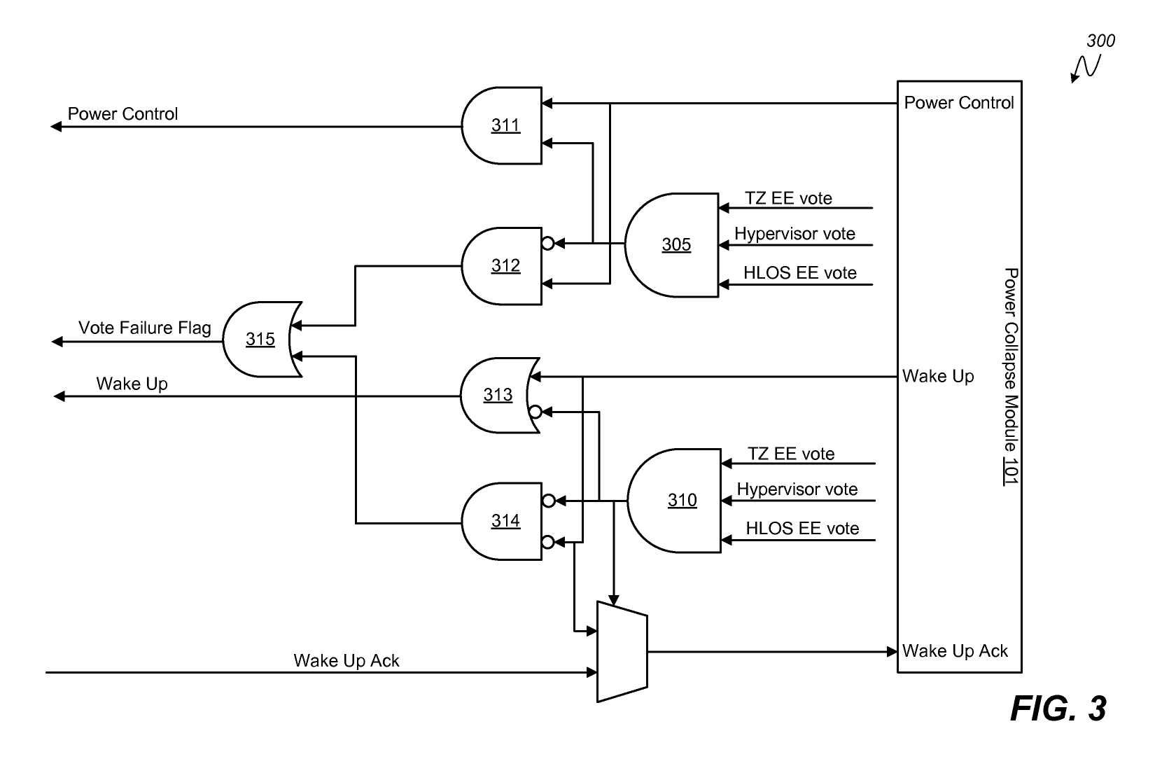

FIG. 3 is a circuit diagram 300 of an exemplary HMPM embodiment for managing power states of a cache component 112C in a system on a chip (“SoC”) 102 running multiple execution environments 25, 27, 29. Notably, although the circuit diagram 300 is depicted as separate from the PC module 101, it is envisioned that means for performing the HMPM functionality represented by the circuit diagram 300 may be comprised within the PC module 101.

As one of ordinary skill in the art would understand, although the exemplary circuit diagram 300 is formed of a combination of “AND” and “OR” type logical gates, other circuit arrangements using the same logical gate types or alternative logical gate types may generate an equivalent output for a given set of inputs. Various circuit arrangements for receiving state machine inputs from execution environments and generating an output to control a power supply will occur to those of ordinary skill in the art and, as such, the particular arrangement of logical gates depicted in the FIG. 3 illustration will not limit the scope of an HMPM solution. Further, the FIG. 3 illustration is a high level depiction of a logical circuit that may be a part of an HMPM solution and, as such, is offered for illustrative purposes.

As described in this specification, the PC module 101 may monitor current states of state machines uniquely associated with various execution environments running in the PCD 100. In the FIG. 3 illustration, the current states for each execution environment are labeled as “votes” from a TZ execution environment 27, a Hypervisor 25 and an HLOS execution environment 29. In the FIG. 3 illustration, the votes are received at one of “AND” gates 305 or 310. Based on the combination of votes, an HMPM embodiment may generate a series of outputs that translate through gates 311, 312, 313, 314 and 315 to generate logical output that triggers either power up a cache component, power collapsing a cache component, or allowing the power state to a cache component to remain unchanged.

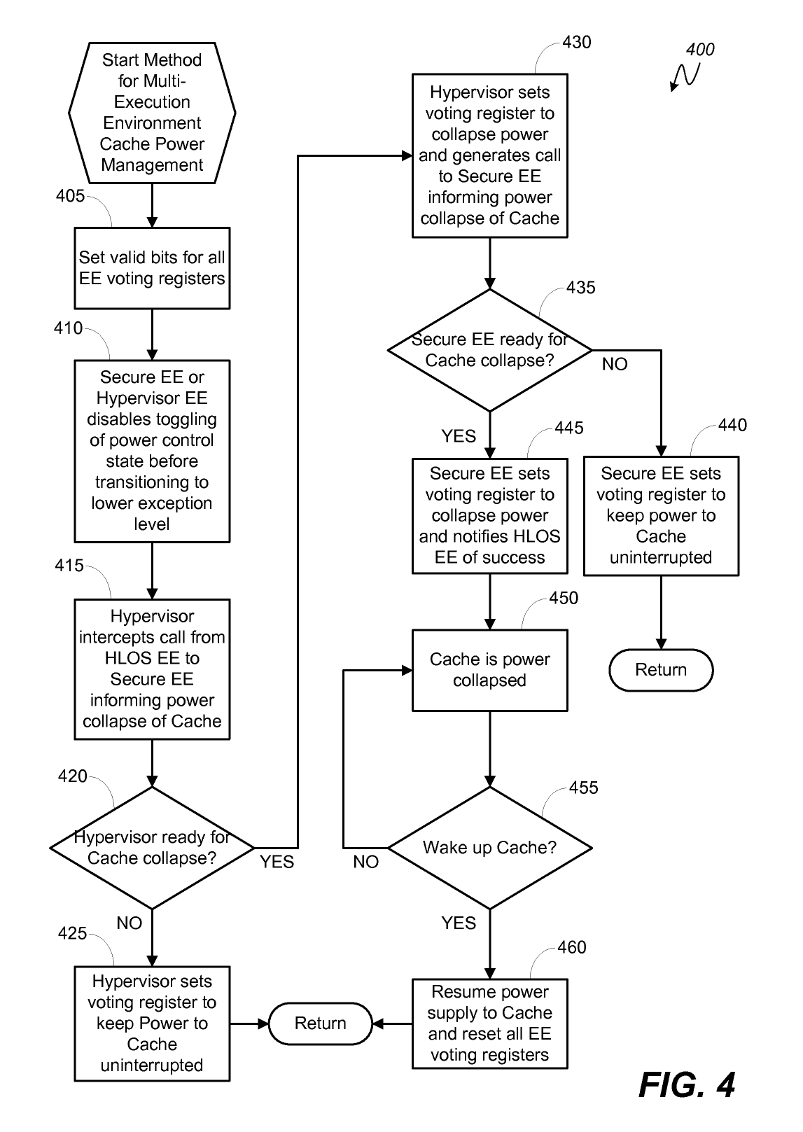

FIG. 4 is a logical flowchart illustrating an embodiment of a method 400 for hardware-based memory power management of a cache 112C in a PCD 100 running a “TrustZone” secure execution environment 27, an HLOS execution environment 29 and a Hypervisor virtual manager 25. Beginning at block 405, all valid bits may be set for each voting register associated with an execution environment 25, 27, 29. Notably, based on the valid bit settings an HMPM embodiment may recognize logical combinations of votes from the various execution environments 25, 27, 29 and trigger power supply changes to power consuming components on the chip 102.

At block 410, the secure execution environment 27 or the Hypervisor virtual manager 25 may disable toggling of a power control state to a cache 112C before transitioning itself to a lower exception level. Subsequently, at block 415 the Hypervisor virtual manager 25 may intercept a call from the HLOS execution environment 29 to the secure execution environment 27 requesting a power collapse of the cache 112C.

At decision block 420, the Hypervisor may determine if a power collapse of the cache 112C is in order. If not, the “no” branch is followed to block 425 and the Hypervisor 25 keeps its state machine vote to the PC module 101 in a state that indicates the power supply to the cache should remain uninterrupted. If the Hypervisor 25 concurs with the HLOS 29 vote to power collapse the cache 112C, the “yes” branch is followed to block 430. At block 430, the Hypervisor 25 transitions its state machine vote to the PC module 101 to indicate that the power supply to the cache should be collapsed and generates a call to the secure execution environment 27 to place a vote.

At decision block 435, the secure execution environment 27 may decide if it is ready for the cache 112C to be power collapsed. As described above, the secure execution environment 27 may still have data to write to, or read from, the cache 112C before flushing the data to a larger memory component such as DDR 112A or external flash memory 112B. Advantageously, in HMPM embodiments the secure execution environment 27 may override any initiative by the non-secure HLOS execution environment 29 and/or Hypervisor 25 to power collapse the cache 112C at an inopportune time.

Returning to the method 400 at decision block 435, if the secure execution environment 27 does not authorize the power collapse of the cache 112C, the “no” branch is followed to block 440 and the secure execution environment 27 votes via its state machine to keep the power to the cache uninterrupted. If, however, the secure execution environment 27 agrees with the Hypervisor 25 and the HLOS execution environment 29 that the cache 112C should be power collapsed, then the “yes” branch is followed from decision block 435 to block 445.

At block 445, the secure execution environment 27 transitions its state machine output to indicate that it votes to power collapse the cache 112C and notifies the HLOS execution environment 29 that the power collapse is authorized. The method continues from block 445 to block 450 and the PC module 101, recognizing the combination of votes to power collapse the cache 112C, triggers the PMIC 180 to remove power from the power rail associated with the cache 112C. Consequently, the cache 112C is power collapsed.

The cache 112C may remain power collapse until a combination of votes recognized by the PC module 101 triggers a reboot of the cache 112C. The PC module 101 may continue to determine its output state based on the voting inputs from the various execution environments. At decision block 455, if a combination of votes from the various state machines associated with the execution environments that indicates the cache 112C should remain in a sleep or idle state, then the “no” branch is followed back to block 450 and the power supply to the cache remains interrupted. If the PC module 101 recognizes a combination of votes from the various state machines associated with the execution environments that indicates the cache 112C should be powered, then the “yes” branch is followed to block 460 and the PMIC 180 is triggered by an output of the PC module 101 to supply power to the cache 112C. Notably, all voting registers may be reset after a transition in the output of the PC module 101.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently” etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a non-transitory computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for hardware-based memory power management (“HMPM”) in a portable computing device (“PCD”), the method comprising:
instantiating a non-secure execution environment and a secure execution environment, wherein:
both the non-secure execution environment and the secure execution environment utilize a same processor and a same memory component;
a first hardware-based state machine is uniquely associated with, and under the control of, the non-secure execution environment; and
a second hardware-based state machine is uniquely associated with, and under the control of, the secure execution environment;
monitoring states generated by the first and second state machines, wherein the states are indicative of votes by the associated execution environments to control a power supply to the memory component; and
based on a combination of the votes, generating an output signal to trigger control of the power supply to the memory component.

2. The method of claim 1, wherein the memory component is a cache memory.

3. The method of claim 1, wherein:
the combination of votes comprises a vote from the non-secure execution environment to power collapse the memory component and a vote from the secure execution environment to maintain the power supply to the memory component; and
the output signal triggers an uninterrupted power supply to the memory component.

4. The method of claim 1, wherein:
the combination of votes comprises a vote from the non-secure execution environment to maintain the power supply to the memory component and a vote from the secure execution environment to maintain the power supply to the memory component; and
the output signal triggers an uninterrupted power supply to the memory component.

5. The method of claim 1, wherein:
the combination of votes comprises a vote from the non-secure execution environment to power collapse the memory component and a vote from the secure execution environment to power collapse the memory component; and
the output signal triggers removal of the power supply to the memory component.

6. The method of claim 5, further comprising:
flushing the memory component to a second memory component before generating the output signal, wherein the second memory component is selected from a group comprised of a double data rate (“DDR”) memory component and an external flash memory component.

7. The method of claim 1, further comprising:
instantiating a virtual manager to marshal access by the non-secure execution environment and the secure execution environment to the same processor and same memory component, wherein a third hardware-based state machine is uniquely associated with, and under the control of, the virtual manager;
monitoring states generated by the first, second and third state machines, wherein the states are indicative of votes to control a power supply to the memory component; and
based on a combination of the votes, generating an output signal to trigger control of the power supply to the memory component.

8. A computer system for hardware-based memory power management (“HMPM”) in a portable computing device (“PCD”), the system comprising:
a processor for:
instantiating a non-secure execution environment and a secure execution environment, wherein:
both the non-secure execution environment and the secure execution environment utilize the processor and a same memory component;
a first hardware-based state machine is uniquely associated with, and under the control of, the non-secure execution environment; and
a second hardware-based state machine is uniquely associated with, and under the control of, the secure execution environment;
a power control (“PC”) module for:
monitoring states generated by the first and second state machines, wherein the states are indicative of votes by the associated execution environments to control a power supply to the memory component; and
based on a combination of the votes, generating an output signal to trigger control of the power supply to the memory component.

9. The computer system of claim 8, wherein the memory component is a cache memory.

10. The computer system of claim 8, wherein:
the combination of votes comprises a vote from the non-secure execution environment to power collapse the memory component and a vote from the secure execution environment to maintain the power supply to the memory component; and
the output signal triggers an uninterrupted power supply to the memory component.

11. The computer system of claim 8, wherein:
the combination of votes comprises a vote from the non-secure execution environment to maintain the power supply to the memory component and a vote from the secure execution environment to maintain the power supply to the memory component; and
the output signal triggers an uninterrupted power supply to the memory component.

12. The computer system of claim 8, wherein:
the combination of votes comprises a vote from the non-secure execution environment to power collapse the memory component and a vote from the secure execution environment to power collapse the memory component; and
the output signal triggers removal of the power supply to the memory component.

13. The computer system of claim 12, wherein the processor is further operable for:
flushing the memory component to a second memory component before the PC module generates the output signal; and
the second memory component is selected from a group comprised of a double data rate (“DDR”) memory component and an external flash memory component.

14. The computer system of claim 8, wherein:
the processor is further operable for:
instantiating a virtual manager to marshal access by the non-secure execution environment and the secure execution environment to the same processor and same memory component, wherein a third hardware-based state machine is uniquely associated with, and under the control of, the virtual manager; and
the PC module is further operable for:
monitoring states generated by the first, second and third state machines, wherein the states are indicative of votes to control a power supply to the memory component; and
based on a combination of the votes, generating an output signal to trigger control of the power supply to the memory component.

15. A computer system for hardware-based memory power management (“HMPM”) in a portable computing device (“PCD”), the system comprising:
means for instantiating a non-secure execution environment and a secure execution environment, wherein:
both the non-secure execution environment and the secure execution environment utilize a same processor and a same memory component;
a first hardware-based state machine is uniquely associated with, and under the control of, the non-secure execution environment; and
a second hardware-based state machine is uniquely associated with, and under the control of, the secure execution environment;
means for monitoring states generated by the first and second state machines, wherein the states are indicative of votes by the associated execution environments to control a power supply to the memory component; and
means for generating an output signal to trigger control of the power supply to the memory component based on a combination of the votes.

16. The computer system of claim 15, wherein the memory component is a cache memory.

17. The computer system of claim 15, wherein:
the combination of votes comprises a vote from the non-secure execution environment to power collapse the memory component and a vote from the secure execution environment to maintain the power supply to the memory component; and
the output signal triggers an uninterrupted power supply to the memory component.

18. The computer system of claim 15, wherein:
the combination of votes comprises a vote from the non-secure execution environment to maintain the power supply to the memory component and a vote from the secure execution environment to maintain the power supply to the memory component; and
the output signal triggers an uninterrupted power supply to the memory component.

19. The computer system of claim 15, wherein:
the combination of votes comprises a vote from the non-secure execution environment to power collapse the memory component and a vote from the secure execution environment to power collapse the memory component; and
the output signal triggers removal of the power supply to the memory component.

20. The computer system of claim 15, further comprising:
means for instantiating a virtual manager to marshal access by the non-secure execution environment and the secure execution environment to the same processor and same memory component, wherein a third hardware-based state machine is uniquely associated with, and under the control of, the virtual manager;
means for monitoring states generated by the first, second and third state machines, wherein the states are indicative of votes to control a power supply to the memory component; and
means for generating an output signal to trigger control of the power supply to the memory component based on a combination of the votes.
